(19) United States
(12) Patent Application Publication
(10) Pub. No.: US 2015/0237839 A1
(43) Pub. Date: Aug. 27, 2015

(54) ICE FISHING TIP-UP HOLDER

(71) Applicant: Alan A. Hermanson, Sun Lakes, AZ (US)

(72) Inventor: Alan A. Hermanson, Sun Lakes, AZ (US)

(21) Appl. No.: 14/191,735

(22) Filed: Feb. 27, 2014

(51) Int. Cl. A01K 97/12; A01K 97/01

(52) U.S. Cl. CPC A01K 97/12; A01K 97/01

(57) ABSTRACT

A tip-up holder for use with a tip-up while ice fishing comprising a hollow housing, where the housing includes at least four walls extending between a top edge and a bottom edge, and where the housing is positioned over an ice hole; a plurality of indentions positioned along the top edge of the housing, where the plurality of indentions receive a tip-up, where a first end of the tip-up is positioned within one indention and a second end of the tip-up is positioned within an indention on an opposing wall; and a set of anchors at the bottom edge of the housing, where the set of anchors secure the housing above the ice hole.

### BACKGROUND OF THE INVENTION

1. Field of the Invention

The present invention relates to a device with numerous indentions to accommodate receiving a fishing tip-up thereby facilitating viewing the tip-up from a distance during ice fishing.

2. Description of Related Art

Ice fishing is a sport enjoyed both professionally and casually by many individuals. The practice enables a person to catch fish in a frozen body of water. The fishermen gain access to the fish by drilling a hole through the top layer of ice, through which they place their lines. Only the top surface of the water is frozen providing fresh water for the fish to survive. Sometimes the fisherman merely sits on a stool or chair next to the drilled hole, and allows themselves to be exposed and open to the surrounding elements. Alternatively, the fisherman may be within a shelter like a cabin which provides protection from extreme weather. Many cabins are equipped with heating elements, and some even include beds or bunks for the user's convenience.

Many fisherman utilize tip-ups which are flagged lures that indicate when a fish is caught. The fisherman may set up numerous tip-ups on the ice, and then observe them from a distance or in a shelter. When the flag stands erect this indicates that a fish is at the end of the line so the fisherman reels them in for consumption. Because of the extreme nature of the weather where ice fishing takes place, the tip-ups are often covered with snow or blown over in the wind. Also, the tip-ups sometimes get frozen into the ice hole because the ice refreezes after extended exposure to cold temperatures.

In light of the foregoing circumstances, it would be beneficial in the art to provide a holder for a tip-up to prevent the tip-up from falling or blowing away during use. It would also be desirable in the art to provide a device that shields the ice hole from the external weather to prevent the ice hole from refreezing while fishing.

### SUMMARY OF THE INVENTION

In view of the foregoing disadvantages inherent in the prior art, the general purpose of the present invention is to provide a tip-up holder for use with a tip-up while ice fishing, configured to include all of the advantages of the prior art, and to overcome the drawbacks inherent therein. Accordingly, an object of the present invention is to provide a holder for a tip-up to anchor and elevate the tip-up above the ice while fishing.

Another object of the present invention is to provide a tip-up holder with elevated walls to shield and protect the underlying ice hole from refreezing.

To achieve the above objects, in an aspect of the present invention, a tip-up holder is described comprising a hollow housing, where the housing includes at least four walls extending between a top edge and a bottom edge, and where the housing is positioned over an ice hole; a plurality of indentions positioned along the top edge of the housing, where the plurality of indentions receive a tip-up, where a first end of the tip-up is positioned within one indention and a second end of the tip-up is positioned within an indention on an opposing wall; and a set of anchors at the bottom edge of the housing, where the set of anchors secure the housing above the ice hole.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing in which:

FIG. 1 depicts a perspective view of a tip-up holder in accordance with an exemplary embodiment of the present invention.

### DETAILED DESCRIPTION OF THE DRAWINGS

The present invention relates to a device with numerous indentions to accommodate receiving a fishing tip-up thereby facilitating viewing the tip-up from a distance during ice fishing. The present invention provides a tip-up holder to elevate and support a tip-up above the ice while out ice fishing. The tip-up holder is a hollow tower that is positioned over a fishing hole. The top edges of the tower include notches to receive and secure the tip-up. By elevating the tip-up the fisherman is able to more easily see the tip-up flag from a distance, thereby allowing for faster awareness as to when a fish is caught.

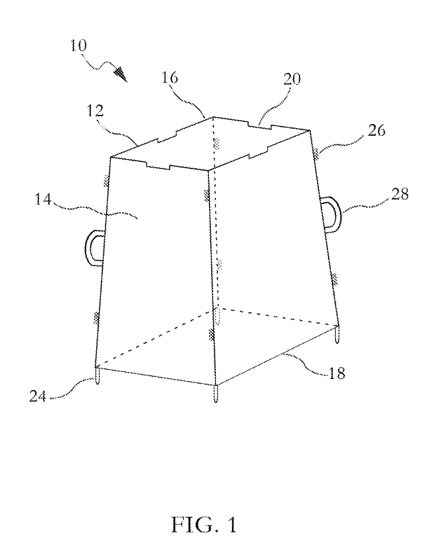

Turning now descriptively to the drawings, referring to FIG. 1, a tip-up holder 10 is shown in accordance with an exemplary embodiment of the present invention. The tip-up holder 10 includes a housing 12 with at least four walls 14 extending between a top edge 16 and a bottom edge 18 to create a square or cubed structure. Six or eight walls 14 may alternatively comprise the housing 12. The housing 12 is open along the top 16 and bottom edges 18 providing a hollow structure. During use, the tip-up holder 10 is positioned over an ice hole to allow access into the hole through the walls 14 of the housing 12. The housing 12 may be made from wood, plastic, steel, aluminum, rubber or similar materials able to withstand exposure to extremely cold temperatures.

Along the top edge 16 may be a plurality of intentions 20. One indention 20 may be positioned atop each wall 14 within the center of the top edge 16. The indention 20 receives a fishing tip-up where a first end of the tip-up is positioned within the indention 20 of one wall 14 and then a second end of the tip-up is positioned within the indention 20 of the opposing wall 14.

The line and lure of the tip-up pass through the housing into the underlying ice hole. The walls 14 may stand approximately 12-36 inches tall thereby elevating the tip-up above any snow or debris accumulated around the hole.

The bottom edge 18 may include a plurality of anchors 24. The anchors 24 may be stakes or spikes that drive into the ice thereby holding the housing 12 in place on the ice and snow. The anchors 24 may be positioned anywhere along the bottom edge 18 and may be especially useful at the corners of the housing 12 (as illustrated). The anchors 24 may be steel, hardened plastic or the like to efficiently drive them into the ice.

Connecting the walls 14 to each other may be a plurality of fasteners 26. The fasteners 26 may be nails, staples or screws. Alternatively, the fasteners 26 may be hinges allowing the walls 14 to collapse the housing 12 when not in use. For easy transport, a pair of handles 28 may be attached to the walls 14. As illustrated the handles 28 are positioned along the sides of the housing 12. The handles 28 may be optionally positioned along the top edge 16, as preferred by the user.

With the tip-up holder 10 the user is afforded peace of mind that their tip-ups are easily visible above the snow. Additionally, the holder 10 securely anchors the tip-ups over the fishing hole to prevent them from tipping or falling into the water. By positioning the tip-up holder 10 directly above the ice hole, the hole is protected from surrounding snow and wind to prevent snow from accumulating and ice from reforming which both may cause the hole to close. The holder 10 is practical and easy to use for any avid ice fisherman. The user is provided a uniquely simple tool to raise the tip-up thereby allowing more fish to be caught.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A tip-up holder for use with a tip-up while ice fishing comprising:
a. a hollow housing, where the housing includes at least four walls extending between a top edge and a bottom edge, and where the housing is positioned over an ice hole;
b. a plurality of indentions positioned along the top edge of the housing, where the plurality of indentions receive a tip-up, where a first end of the tip-up is positioned within one indention and a second end of the tip-up is positioned within an indention on an opposing wall; and
c. a set of anchors at the bottom edge of the housing, where the set of anchors secure the housing above the ice hole.

2. The tip-up holder according to claim 1, where the walls are attached to each other with a plurality of fasteners.

3. The tip-up holder according to claim 2, where the plurality of fasteners are one of at least nails, screw, or staples.

4. The tip-up holder according to claim 2, where the plurality of fasteners is hinges, where the hinges enable the walls to collapse and close the housing.

5. The tip-up holder according to claim 1, where the wall includes at least one handle to transport the housing.

6. The tip-up holder according to claim 5, where the handle is attached along a side of the housing.

7. The tip-up holder according to claim 5, where the handle is attached along the top edge.

8. The tip-up holder according to claim 1, where the plurality of anchors are stakes.

9. The tip-up holder according to claim 1, where the housing includes six walls.

10. The tip-up holder according to claim 1, where the housing includes eight walls.
